(19) United States
(12) Patent Application Publication
(10) Pub. No.: US 2024/0371568 A1
(43) Pub. Date: Nov. 7, 2024

(54) On-load Tap Changer Module, Assembly Composed of an On-load Tap Changer Module and a Power Transformer, and Method for Operating an On-load Tap Changer Module

(71) Applicants: Infineon Technologeis Bipolar GmbH & Co. KG, Warstein (DE); Siemens Gamesa Renewable Energy Innovation & Technology S.L., Sarriguren (ES)

(72) Inventors: Jürgen Schiele, Baesweiler (DE); Manex Barrenetxea Inarra, Arrasate (ES); Jose Maria Canales Segade, Durango (ES); Nils Przybilla, Warstein (DE); Miguel Rodriguez Vazquez, Warstein (ES); Fernando Santodomingo, Las Palmas de Gran Canaria (ES)

(21) Appl. No.: 18/556,786

(22) PCT Filed: Apr. 25, 2022
(86) PCT No.: PCT/EP2022/060828

§ 371 Date: Oct. 23, 2023

(30) Foreign Application Priority Data
Apr. 30, 2021 (DE) 10 2021 111 181.1

(51) Int. Cl. H01F 29/02

(52) U.S. Cl. CPC H01F 29/02

(57) ABSTRACT

The invention relates to an on-load tap changer module (1, 15), in particular a power electronic on-load tap changer module, for adjusting a transformation ratio of a power transformer (2) having at least one transformer winding providing at least one tap (3), having: a control device (6), at least one tap changer (7) which can selectively be connected and disconnected by means of the control device (6) in order to adjust the transformation ratio of the power transformer (2), and at least one crowbar (11) for voltage limitation, which is adapted, when a predetermined threshold voltage value is exceeded, to provide a predetermined current path for determining a predetermined transformation ratio of the power transformer.

The invention relates further to an assembly consisting of a power transformer (2) and an on-load tap changer module (1, 15) and to a method for operating an on-load tap changer module.

### TECHNICAL FIELD

The present invention relates to an on-load tap changer module, in particular a power electronic on-load tap changer module, for adjusting a transformation ratio of a power transformer having at least one transformer winding providing at least one tap. The invention relates further to an assembly comprising a power transformer having at least one transformer winding providing at least one tap, and an on-load tap changer module for adjusting a transformation ratio of the power transformer. The invention relates additionally to a method for operating an on-load tap changer module.

### BACKGROUND

Tap changers for power transformers are used in a manner known per se for adjusting the transformer transformation ratio. The winding of the transformer can have on its high- or low-voltage side, for example, a principal winding and a regulating or tap winding having one or more taps (likewise referred to herein as winding tap or tap for short), which is/are guided to the tap changer.

On-load tap changers are used for changing the transformation ratio under load without interruption. For voltage regulation, the transformation ratio is adjusted by connecting and disconnecting the tap winding, or winding portions of the tap winding that are defined by the taps. In power electronics, electronic valves or switches can be used for this purpose. Electronic valves or switches are functional elements which can alternately be moved into the conducting and non-conducting state.

In systems, for example wind power installations, in which transformers or autotransformers which are connected to high-voltage (greater than 69 kV), medium-voltage (between 1 kV and 69 kV) or even low-voltage networks (below 1 kV) are used, the problem of voltage instabilities frequently occurs. Such instabilities can be exacerbated in power generation installations which are connected to a power network and must meet the demands of the network. It is entirely possible here that the voltage may vary between approximately −20% and +20% of the nominal voltage. This results in an oversizing of the system as a whole and in less efficient operating conditions. In order to solve this problem and to be cost-efficient, it is known to equip such installations with tap changers. These are conventionally produced with mechanical switches, which are usually integrated in the transformer. A disadvantage of the use of such mechanical switches is that mechanical tap changers are slow and therefore unable to respond to rapid voltage drops and/or overvoltages.

An alternative solution is the thyristor-based tap changer. Thyristors are rapid and maintenance-free switches which permit a rapid response to rapid voltage dips and/or overvoltages. However, the thyristors may fail in some situations, which results in damage to the transformer. In addition, undefined switching states of such thyristors, for example when starting up or ramping up the installation/system, can result in voltages being present between the taps of the transformer winding which reach or even exceed the level of the supply voltage. This can have undesirable consequences, such as total failure of the installation/system, or, in the worst case, the thyristor-based tap changers can be damaged under such operating conditions.

### SUMMARY

Against this background, the invention is based on the object of providing an on-load tap changer module, in particular a power electronic on-load tap changer module, for adjusting a transformation ratio of a power transformer or autotransformer, an assembly comprising a power transformer or autotransformer and an on-load tap changer module, and a method for operating an on-load tap changer module, which ensure reliable, safe, low-maintenance and long-lasting operation of electrical installations/systems, for example wind power installations. The on-load tap changer module is also to be able to provide protection in the case of transient high voltage or surge voltage events. In addition, the on-load tap changer module is to be of simple construction and is to be able to be provided retrospectively, without a great outlay, even to already existing electrical installations/systems, for example.

This object is achieved by an on-load tap changer module, an assembly comprising a power transformer or autotransformer and an on-load tap changer module, and a method for operating an on-load tap changer module each described herein. Further advantageous embodiments of the invention are also disclosed.

It should be pointed out that the features listed individually in the claims can be combined with one another in any technically expedient manner (also across category boundaries, for example between the method and the device) and indicate further embodiments of the invention. The description additionally characterizes and specifies the invention in particular in association with the figures.

It should further be pointed out that a conjunction “and/or” which is used herein between two features and links them together is always to be interpreted such that in a first embodiment of the subject matter according to the invention only the first feature can be present, in a second embodiment only the second feature can be present, and in a third embodiment both the first and the second feature can be present.

In addition, a term “approximately” used herein is to indicate a tolerance range which is considered usual by a person skilled in the present field. In particular, the term “approximately” is to be understood as meaning a tolerance range of the value in question of up to a maximum of +/−20%, preferably up to a maximum of +/−10%.

According to the invention, an on-load tap changer module (OLTC) for adjusting a transformation ratio of a power transformer having at least one transformer winding providing at least one tap has a control device (e.g. an electronic control device such as a computing and memory unit, for example a microprocessor, microcontroller or the like, optionally in conjunction with RAM, ROM, flash memory, etc.), at least one tap changer which can selectively be connected and disconnected by means of the control device in order to adjust the transformation ratio of the power transformer, and at least one crowbar for voltage limitation which is adapted to provide a predetermined current path for determining a predetermined transformation ratio of the power transformer when a predetermined threshold voltage value is exceeded.

The crowbar is an electrical and/or electronic circuit which serves to protect against overvoltage and, when the predetermined threshold voltage value, for example approximately 7 kV, is reached at terminals of the crowbar, short circuits this applied voltage.

Within the meaning of the invention, a power transformer can be understood as being an electrical transformer which is designed for power ratings in the range of, for example, from approximately 1 MVA to approximately 100 MVA. These are to include in particular devices in electrical energy networks/energy systems, which can frequently be in the form of a single-or multi-phase, for example three-phase, alternating current transformer or also in the form of an autotransformer.

A toggle diode structure (also referred to as a Schockley diode and, for the sake of simplicity, likewise referred to herein as a toggle diode for short) can be interpreted as being a four-layer diode structure, that is to say a silicon semiconductor component with four differently doped semiconductor zones and three pn junctions. When a particular voltage of corresponding polarity is exceeded at the diode terminals (i.e. anode and cathode), the diode structure toggles into a low-impedance, conducting state (breakover). This state persists until the current falls below a particular holding current. The diode structure then toggles into the high-impedance starting state again.

The toggle diode structure can be in the form of a break-over diode structure (also referred to as a BOD structure).

The term “crowbar” is to be understood as meaning a device which consists of a single element or of a plurality of single elements which are so adapted and designed that they electrically connect together two points of a transformer and establish a predefined maximum voltage between those points. The crowbar can be so adapted and designed that it is activated, for example, when at least the control system or control device of the transformer is not supplied with power or when a fault occurs under normal operating conditions.

The expression “mechanical clamping device” is here to be understood as meaning a device which is so adapted and designed that it exerts mechanical pressure on an electronic component, such as, for example, a thyristor, or on a plurality of such components, in order to permit correct operation thereof.

The expression “cold start” is to be understood herein as meaning a state in which the transformer/tap changer or at least the control system/control device of the tap changer is not supplied with electricity. In this state, the transformation ratio of the transformer cannot be adjusted by the control device, but it can be adjusted in a defined manner by the crowbar.

The expression “ramp up/start up” is to be understood herein as meaning a transformer state or operation in which the crowbar is activated or short circuited, that is to say when at least the control device is not supplied with electricity (cold-start situation). During start up, the crowbar connects two points of the tap changer and thus closes a circuit by which a voltage is applied to the tap changer module and the transformer/system as a whole, for example until they are properly controlled.

The term “autostart” is to be interpreted herein as meaning the ability or process by which a system activates itself when the control system/control device is unable to control the system, for example owing to the absence of a power supply or during the recovery period following restoration of the power supply (the control system usually requires a certain time to charge and be fully ready for operation). That is to say, by means of the autostart, it is possible to impose on the system, that is to say the tap changer, a predefined state in which it can operate or run while the control system is not capable of doing so and until the control system restores proper operational control.

The terms “transformer” and “autotransformer” are used interchangeably herein.

The on-load tap changer module according to the invention can correspondingly be adapted to the electrical voltages that occur in a particular application, from which the crowbar is to short circuit the taps connected together within the meaning of the desired voltage limitation.

In this way, the on-load tap changer module according to the invention ensures that the crowbar is activated in the case of a defined overvoltage between its respective terminals and the system is able to run under safe conditions. An overvoltage can occur, for example, if the controllable tap changers are in an undefined switching state, for example during ramping up or in the case of (brief) power failures/interruptions of the system, when the control device is not properly supplied with power and accordingly proper control of the tap changers by the control device is not (yet) ensured. As soon as there is no longer an overvoltage between the taps, for example because the control device has assumed proper control of the tap changers, the crowbar returns to its high-impedance starting state, in which there is substantially no conducting electrical connection between its terminals. In this state, the crowbar does not influence or interfere with normal operation of the system. The on-load tap changer module according to the invention thus provides the electrical installation/system (e.g. a transformer or autotransformer) with a reliable auto-start capability.

Even in the case of disrupted operation of one or more of the tap changers or of the on-load tap changer module, the crowbar ensures safe operation in the above-described way. After the switch fault has been eliminated, the crowbar continues its normal operation again, that is to say in which it does not interfere with or adversely affect the normal operation of the system.

Even if the crowbar were to be damaged, for example in the form of a short circuit between its terminals, safe operation of the system as a whole continues to be ensured because the transformer taps connected together by way of the crowbar are accordingly likewise short circuited and remain short circuited until the fault of the crowbar has been eliminated or the crowbar has been replaced by a functional crowbar.

The on-load tap changer module according to the invention ensures reliable and safe operation of electrical installations/systems, for example low-, medium- or high-voltage installations/systems. Because the crowbar switches between its high-impedance starting state and its low-impedance, conducting state automatically, that is to say without external activation, the on-load tap changer module is additionally particularly low-maintenance, for example where a toggle or break-over diode structure is provided in the crowbar, wherein the break-over diode structure can advantageously be provided, for example, by a thyristor, in particular a light-triggered thyristor (LTT), without necessarily being limited thereto. The on-load tap changer module ensures safe operation of the system as a whole even in the case of transient, rapid high voltage or surge voltage events at the power transformer. Moreover, safe operation can likewise be ensured when internal disruptive or fault events occur as well as during powering up or start-up of the system. Even already existing installations/systems can easily be retrofitted with the on-load tap changer module according to the invention and thus improved in terms of safety.

According to an advantageous development of the subject matter of the invention, the on-load tap changer module can have at least three tap changers which are each connected to one another by way of a first electrical terminal and are each able to be connected by way of a winding-side, second electrical terminal to one of a plurality of taps of the transformer winding, wherein the winding-side second terminals of at least two of the tap changers are electrically connected together by way of the crowbar for voltage limitation.

According to a further embodiment, the crowbar can have at least one thyristor.

Furthermore, according to another embodiment, the crowbar can have at least one toggle diode structure having a predetermined breakdown voltage. The toggle diode structure can be provided, for example, by a thyristor, without necessarily being limited thereto.

The toggle diode structure can electrically connect together winding-side terminals, for example, of the tap changers.

According to yet a further advantageous embodiment, the crowbar can have a pair of toggle diode structures which are connected in anti-parallel and each have a predetermined breakdown voltage. The predetermined breakdown voltages of the toggle diode structures can be substantially identical. However, they can also be different, so that different operating states of the electrical system can suitably be taken into account.

According to an advantageous embodiment of the invention, the at least one tap changer has between its terminals a pair of power semiconductor switches which are connected in anti-parallel and are controllable by the control device.

For example, the power semiconductor switch can advantageously be in the form of a thyristor which is controllable in a manner known per se by the control device. The thyristor-based on-load tap changer module is distinguished by long-lasting, low-maintenance or maintenance-free operation. Moreover, the thyristor permits rapid and energy-efficient switching of the tap changer and thus improves the responsiveness of the on-load tap changer module and the overall efficiency of the operated electrical installation. The on-load tap changer module is also able to react appropriately to rapid events of high voltage intensity (e.g. transient surge voltages) without external control, so as to prevent damage to itself and to the connected system.

According to a further preferred embodiment of the invention, the thyristor is a light-triggered thyristor (also called an LTT). The advantage of an optical control signal compared to an electrical control signal lies, inter alia, in better EMV protection because, compared to an electrical line, an optical line for the control signal to a light-sensitive triggering structure of the thyristor (for example by way of glass fibers) is insensitive to incorrect triggering by very high electrical and magnetic fields, caused by very high current and voltage changes in the vicinity of the on-load tap changer module. Furthermore, an optical control signal offers advantages in the case of high potential differences at the on-load tap changer module (insulation with respect to very high voltage differences in the 1 kV to 100 kV range).

Yet a further advantageous embodiment of the invention provides that the control device is supplied solely from the electrical voltage (e.g. medium/high voltage) which is to be transformed by the power transformer or which is supplied to or can be drawn from the power transformer. In other words, it is possible to dispense with an auxiliary power source for additionally supplying the control device with power independently of the electrical energy supplied to the transformer (i.e. cost saving as well as simpler, more compact and maintenance-free construction). The auto-start capability of the on-load tap changer module is in any case ensured even if the control device or on-load tap changer module does not have its own power supply, as is explained in detail herein.

According to another advantageous development of the subject matter of the invention, the toggle diode structure is in the form of a thyristor with a break-over diode structure (BOD). The thyristor can be, for example, an electrically triggered or light-triggered thyristor. In this case, the electrical or light-based control of the thyristor does not necessarily have to be used for the invention, because the function according to the invention can be provided simply by the toggle diode structure or BOD integrated therein.

Configuring the toggle diode structure or the crowbar as a thyristor or thyristors, while at the same time also configuring the tap changers as thyristors, additionally offers particular mechanical advantages. In particular, the thyristors forming the power semiconductor switches and the thyristor(s) forming the toggle diode structure can in this case be arranged so that they are stacked, in particular stacked one above the other, in a common thyristor stack and are press-contacted, for example, whereby a modular and in particular compact construction of the on-load tap changer module can be achieved. Moreover, the modular thyristor stack in the form of a press stack can also replace, even in already existing installations, a conventional thyristor stack which is already in use and does not have a crowbar within the meaning of the invention.

According to a particularly preferred embodiment of the invention, the power transformer is a high-voltage transformer, that is to say a transformer which is adapted to transform electrical voltages greater than 1 kV, for example medium-high voltages in the range of approximately from 1 kV to 50 kV or approximately from 1 kV to 60 kV or also high voltages above 60 kV.

According to a further aspect of the invention there is disclosed an assembly comprising a power transformer having at least one transformer winding providing at least one tap, and an on-load tap changer module according to one of the embodiments disclosed herein for adjusting a transformation ratio of the power transformer. Winding-side electrical terminals of the tap changer(s) are here each connected to one of the taps of the transformer winding.

It should be noted that, in respect of definitions of terms relating to the assembly and in respect of the effects and advantages of features relating to the assembly, reference is made to the entirety of the disclosures of analogous definitions, effects and advantages of the on-load tap changer module according to the invention disclosed herein. That is to say, disclosures made herein in respect of the on-load tap changer module according to the invention can be used analogously also for the definition of the assembly according to the invention, provided that this is not explicitly excluded. Likewise, disclosures made herein in respect of the assembly according to the invention can be used analogously for the definition of the on-load tap changer module according to the invention, provided that this is not explicitly excluded. In this respect, a repetition of explanations of analogous features, their effects and advantages can be omitted in favor of a more compact description, without such omissions being construed as being a limitation.

According to a further aspect of the invention there is also disclosed a wind power installation having an on-load tap changer module according to one of the embodiments disclosed herein.

According to yet a further aspect of the invention, a method for operating an on-load tap changer module, in particular an on-load tap changer module as disclosed herein, has the following steps:
providing a control device,
providing a power transformer having at least one transformer winding providing at least one tap,
providing at least one tap changer which can selectively be connected and disconnected by means of the control device in order to adjust a transformation ratio of the power transformer,
providing at least one crowbar for voltage limitation, and
providing a predetermined current path by means of the at least one crowbar in the case where a predetermined threshold voltage value is exceeded, in order to determine a predetermined transformation ratio of the power transformer.

Also in respect of the disclosed method according to the invention, it should be noted that, in respect of the definitions of terms relating to the method and in respect of the effects and advantages of features relating to the method, reference is made to the entirety of the disclosures of analogous definitions, effects and advantages of the on-load tap changer module according to the invention disclosed herein, and disclosures made herein in respect of the on-load tap changer module according to the invention and in respect of the method according to the invention can selectively be used analogously also for the definition of the device or on-load tap changer module according to the invention, provided that this is not explicitly excluded. In this respect, a repetition of explanations of analogous features, their effects and advantages can be omitted in favor of a more compact description, without such omissions being construed as being a limitation.

The power transformer can preferably be a high-voltage transformer, as explained in detail elsewhere herein, without necessarily being limited thereto.

Further preferably, the at least one tap changer according to one embodiment can have between its terminals a pair of power semiconductor switches which are connected in anti-parallel and are controllable by the control device, for example in the form of a thyristor (e.g. a light-triggered thyristor), without necessarily being limited thereto.

Furthermore, according to one embodiment, the crowbar can be provided with at least one toggle diode structure having a predetermined breakdown voltage.

According to a preferred embodiment, the crowbar can be provided with a pair of toggle diode structures which are connected in anti-parallel and each have a predetermined breakdown voltage.

The toggle diode structure can likewise be in the form of a thyristor (e.g. LTT) with a break-over diode structure (BOD).

The thyristors of the tap changers and/or of the crowbar can preferably be arranged so that they are stacked, in particular stacked one above the other, in a thyristor stack (also referred to as a press pack), in order to achieve particular mechanical and structural advantages, as is explained in detail herein in connection with the on-load tap changer module according to the invention.

According to a particularly advantageous embodiment of the invention, the control device is supplied solely from the electrical voltage which is to be transformed by the power transformer or is supplied to or can be drawn from the power transformer. That is to say, the control device does not require a separate, additional power supply but is supplied solely from the electrical energy of the installation/system (e.g. a wind power installation or photovoltaic installation or the like) with which the on-load tap changer module according to the invention is operationally associated. Even though the on-load tap changer module does not require its own auxiliary power supply, it ensures safe, controlled and robust start up (i.e. auto-start) of the energy installation, despite the fact that high voltage is (still) absent at the time of the auto-start.

By using a crowbar according to one of the embodiments disclosed herein, the on-load tap changer module can be made safe in the event of an overvoltage. In addition, in the absence of a power supply for the control device, the crowbar is able to control in a defined manner the process of ramping up/starting up the system and ensure defined temporary operation of the tap changer module until the operational power supply to the control device is (re)established.

In addition, by providing a predetermined current path by way of the crowbar in order to bypass one or more predetermined transformer tap windings, accidental switching of tap changer switches can be avoided, which permits quicker control of the on-load tap changer module, because the crowbar can be switched at a predetermined time and with predetermined properties.

### BRIEF DESCRIPTION OF THE DRAWINGS

Further features and advantages of the invention will become apparent from the following description of exemplary embodiments of the invention, which are not to be construed as being limiting, which is explained in greater detail hereinbelow with reference to the drawing, in which, schematically:

FIG. 1A shows a circuit diagram of an exemplary embodiment of an on-load tap changer module according to the invention,

FIG. 1B shows a circuit diagram of a further exemplary embodiment of an on-load tap changer module according to the invention,

FIG. 2A shows a circuit diagram of yet a further exemplary embodiment of an on-load tap changer module according to the invention,

FIG. 2B shows a circuit diagram of a further exemplary embodiment of an on-load tap changer module according to the invention,

FIG. 3A shows a circuit diagram of a further exemplary embodiment of an on-load tap changer module according to the invention,

FIG. 3B shows a circuit diagram of yet a further exemplary embodiment of an on-load tap changer module according to the invention,

FIG. 4A shows a circuit diagram of yet a further exemplary embodiment of an on-load tap changer module according to the invention,

FIG. 4B shows a circuit diagram of a further exemplary embodiment of an on-load tap changer module according to the invention,

FIG. 5 shows a circuit diagram of a further exemplary embodiment of an on-load tap changer module for adjusting a transformation ratio of a power transformer according to the invention,

FIG. 6 shows a more detailed view of the on-load tap changer module of FIG. 5,

FIG. 7 shows yet a further exemplary embodiment of an on-load tap changer module for adjusting a transformation ratio of a power transformer according to the invention, and

FIG. 8 shows a flow diagram of an exemplary embodiment of a method for operating an on-load tap changer module according to the invention.

### DETAILED DESCRIPTION

In the various figures, parts which are equivalent in terms of their function are always provided with the same reference signs, so that such parts are generally also described only once.

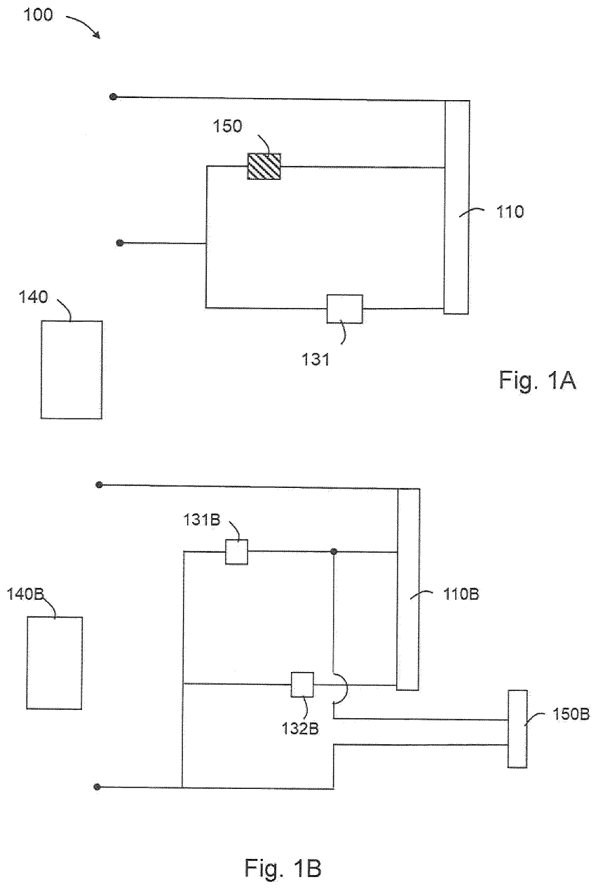

FIG. 1A shows an on-load tap changer module 100 according to an example. The on-load tap changer module 100 can be so adapted and designed that it adjusts a transformation ratio of a power transformer (not shown) to which it can be connected.

The on-load tap changer module 100 can comprise a first transformer winding 110 which has at least one tap, that is to say a winding portion or part which can be de-energized in order to allow a current to flow via a different path, that is to say as an alternative to the current path established through the winding ends, and thus allow the voltage or the transformation ratio to be adjusted.

The on-load tap changer module 100 can have a control system or control device 140, for example a microprocessor, which can be so adapted that it controls the operation of the on-load tap changer module, for example by transmitting command signals. The signals can be transmitted by wire or wirelessly and can be optical signals, for example.

The on-load tap changer module 100 can have at least one tap changer 131 (also referred to herein as the first tap changer) which can be so adapted that it can selectively be connected/disconnected by the control system 140 in order to adjust the transformation ratio of the power transformer.

The at least one (first) tap changer 131 can be connected directly or indirectly, that is to say by way of an impedance, to a point of the transformer winding. In some examples (not shown), the at least one first tap changer 131 can be arranged between an impedance and the first transformer winding.

The tap changer 131 can comprise one or more mechanical or electromechanical switches, for example thyristors, varistors or any other suitable element, which are arranged in parallel or in anti-parallel. For example, the first changer 131 can comprise a pair of light-triggered thyristors (LTTs). The pair of LTTs can be arranged or connected in anti-parallel.

In a further example, the first changer 131 can comprise a pair of electrically triggered thyristors (ETTs). The ETTs can be arranged or connected in anti-parallel and each ETT can have an impedance.

The tap changer module 100 in FIG. 1A can additionally have a crowbar 150, which can be so adapted that, when a predetermined condition, such as, for example, a threshold voltage of, for example, approximately 7 kV, is exceeded, it provides a predefined current path. Thus, if the predetermined threshold voltage is exceeded, the crowbar can be connected, and the crowbar can thus provide a predefined transformation ratio.

This predefined transformation ratio can be the nominal transformation ratio.

In the absence of a power supply to the control system or control device, the crowbar is able to control the system and assume operation of the on-load tap changer module until the power supply for the control system/control device is restored and the control system/control device is able to properly control the on-load tap changer module.

In the example of FIG. 1A, the crowbar 150 is implemented within the tap changer module, that is to say as part of its structure. That is to say, the crowbar 150 can be a switch similar to or in accordance with one of the examples of the first tap changer but which can be connected/disconnected when a predetermined threshold value is exceeded and is not selectively connected/disconnected by the control system or control device 140.

In one example, the on-load tap changer module 100 can have a mechanical clamping device (not shown). The mechanical clamping device can be so arranged that it exerts mechanical pressure on the first tap changer.

FIG. 1B shows an on-load tap changer module 100B, which can comprise a first winding 110, a control system or control device 140, and a first tap changer 131B according to one of the examples disclosed in FIG. 1A.

The on-load tap changer module 100B differs from that shown in FIG. 1A in that it can have a second tap changer 132B and also in that the crowbar 150B can be implemented as a separate element, that is to say as an external element that is not part of the (original) structure of the tap changer. The crowbar 150B can be so arranged that it determines a predefined current path which differs from the current paths defined by the first and second tap changers.

The crowbar 150B can have the same structure as the crowbar of FIG. 1A.

The second tap changer 132B can correspond to any of the examples of the first tap changer which are disclosed herein.

In one example, the on-load tap changer module 100B can have a mechanical clamping device (not shown). The mechanical clamping device can be so arranged that it exerts mechanical pressure on the first and/or second tap changer. In one example, the on-load tap changer module 100B can have two mechanical clamping devices, wherein each mechanical clamping device can be arranged within the first or second tap changer.

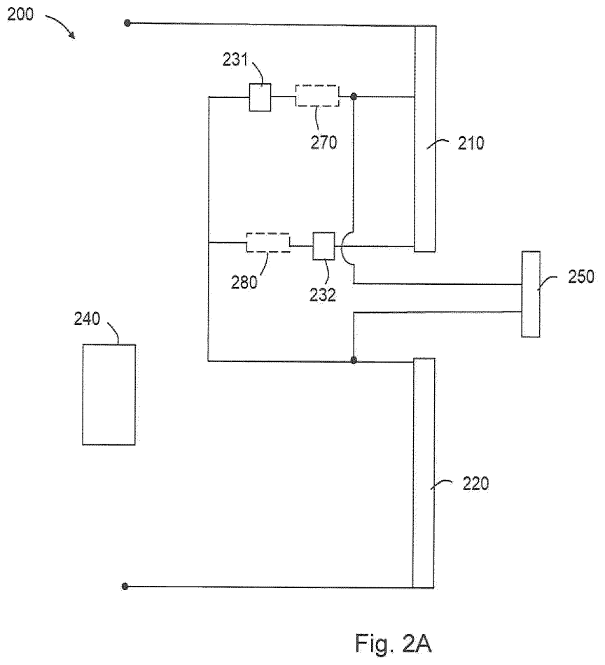

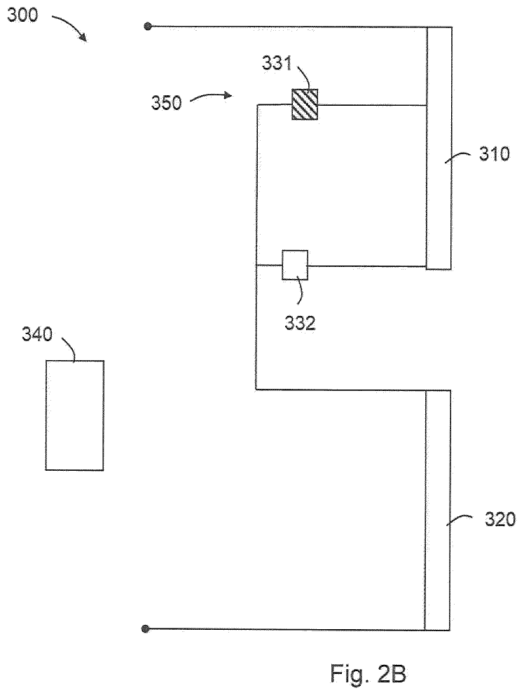

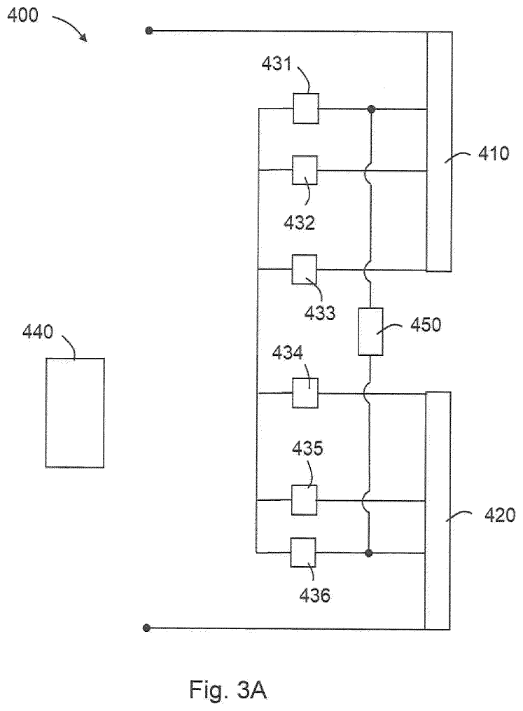

FIG. 2A shows an on-load tap changer module 200 according to a further example. The on-load tap changer module 200 can comprise a first transformer winding 210 and a second transformer winding 220 or any desired other number of windings. The first transformer winding 210 and/or the second transformer winding 220 can have at least one tap.

The on-load tap changer module 200 can further have at least two tap changers, for example a first tap changer 231 and a second tap changer 232, which can selectively be connected and disconnected, for example by way of control signals of the control system or control device, in order to adjust or set the transformation ratio of a power transformer. The number of tap changers can be dependent on the number of transformer windings and/or on the number of different transformation ratios to be adjusted. In some examples, even more than two tap changers can be used.

The first and/or second tap changers 231, 232 can be connected together directly or indirectly, whereby a current path through which current can flow is defined. By connecting and disconnecting the first and second tap changers 231, 232, the transformation ratio can be adjusted, because different current paths can be established between the transformer windings.

The first and second tap changers 231, 232 can comprise one or more mechanical or electromechanical switches, for example thyristors, varistors or any other suitable element, which can be arranged in parallel or in anti-parallel. In one example, each first and second tap changer can have a pair of light-triggered thyristors (LTTs). The pair of LTTs can be arranged in anti-parallel.

In one example, each first and second tap changer 231, 232 can have a pair of electrically triggered thyristors (ETTs). The ETTs can be arranged in anti-parallel and each ETT can have an impedance arranged in series therewith.

In some examples, the on-load tap changer module 200 can have an impedance 270, 280 which is connected to the first or second tap changer. By connecting an impedance, the crossover short-circuit current can be reduced, whereby the tap changer is protected. In one example, the on-load tap changer module 200 can have an impedance 270, 280 which is connected to each of the first and second tap changers. The impedance can be arranged between the tap changer 230, 231 and the transformer winding (see e.g. changer 231 and impedance 270 in FIG. 2A). In one example, the changer 231, 232 can be arranged between the impedance and the winding (see e.g. tap changer 232 and impedance 280 of FIG. 2A).

The on-load tap changer module 200 can have a control system or control device 240, for example a microcontroller, which is able to generate control signals for controlling the operation of the on-load tap changer module 200. The control system 240 can be so adapted that it selectively connects and disconnects the first and second tap changers and in so doing determines different current paths between the first and second transformer windings. The transformation ratio of the transformer can thus be adjusted or adapted. The first and second tap changers 231, 232 can therefore be so adapted that they can selectively be connected and disconnected by the controller.

The on-load tap changer module 200 can additionally have a crowbar 250 for providing a predefined transformation ratio. The crowbar 250 can be so adapted that, when a predetermined threshold voltage, for example an overvoltage value of approximately 7 kV, is exceeded, it provides a predefined current path. The on-load tap changer module 200 can thus be protected in the case of an overvoltage against an internal failure or in the case of a ramp-up/start-up event (cold start), or the tap changer can be protected. In addition, the crowbar can allow the tap changer to be operated in the absence of a power supply to the control device until the power supply for the controller has been properly restored.

The bridging of the transformer tap windings can thus be predefined, that is to say it can take place at a predefined time (when the predetermined threshold voltage is exceeded), wherein the system is able to operate safely owing to the crowbar. In addition, a permanent short circuit between the windings can be avoided, which prevents undesirable effects due to undefined states of the tap changers. Safe operation can thus be ensured.

The crowbar 250 can be arranged at any desired location of each first and second winding, for example at a location at which a tap changer is connected. One end of the crowbar can be connected directly or indirectly to a terminal of the first winding, and the other end can be connected directly or indirectly to a terminal of the second transformer winding. In one example, the crowbar 250 can be so arranged that it provides the current path having the lowest impedance. Therefore, when a threshold voltage is exceeded, the tap changer module can be short circuited in a controlled manner by way of a predetermined path, that is to say an accidental short circuit as a result of undefined changer states can be avoided.

The crowbar 250 can comprise one or more mechanical or electromechanical switches, for example thyristors, varistors, IGBTs or any other suitable element which can be switched at a predefined threshold value.

In one example, the crowbar 250 can have a pair of light-triggered thyristors (LTTs). The pair of LTTs can be arranged in anti-parallel.

In one example, the crowbar 250 can have a pair of electrically triggered thyristors (ETTs). The ETTs can be arranged in anti-parallel and each ETT can have a switch, for example a break-over diode (BOD), a Zener diode, a varistor or another suitable element, connected to gate and anode. In one example, the crowbar can have an impedance. In one example, the crowbar can have a further, for example a diode and an impedance.

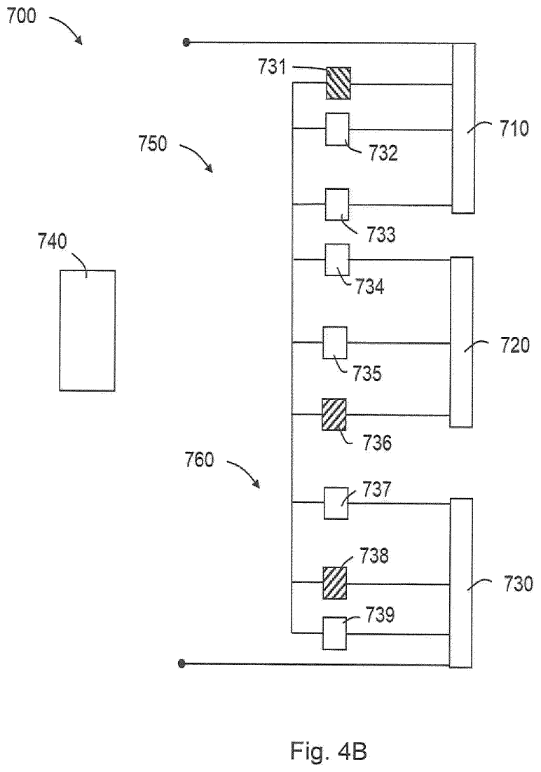

In the examples of FIG. 2A, an on-load tap changer module having two windings and a single crowbar which connects the first and second transformer windings is shown. In some examples (see FIG. 4A, 4B), however, the tap changer module can comprise more than two windings.

In examples in which the tap changer module comprises two or more windings, it can have a plurality of crowbars. The number of crowbars can be dependent on the number of windings, except in examples which comprise a single transformer winding, in which the number of crowbars can correspond to the number of windings, for example one. In one example, the number of crowbar(s) n-1 can correspond to the number of transformer windings, that is to say a crowbar can be used for each pair of transformer windings. In examples which comprise three transformer windings, two crowbars, for example, can be used (each having a pair of windings). In examples which comprise five windings, four crowbars can be used.

The tap changer module 200 can additionally have a mechanical clamping device (not shown) which is so adapted that it exerts mechanical pressure at least on the crowbar and in so doing ensures proper operation. In one example, the changers and the crowbar(s) of the on-load tap changer module 200 can be arranged within a single mechanical clamping device. In one example, a plurality of mechanical clamping devices can be used. For example, each changer and/or each crowbar can be arranged within a respective mechanical clamping device.

FIG. 2B shows an on-load tap changer module 300 which is similar to the on-load tap changer module 200 from FIG. 2A but wherein the crowbar 350 can be formed by one or more tap changers of the on-load tap changer module, for example by the first tap changer or the second tap changer. In the example of FIG. 2B, the first tap changer 331 is designed as the crowbar 350.

The changer that implements the crowbar 350 can be a changer which is similar to or in accordance with one of the examples disclosed herein, but which can be connected/disconnected when a predetermined threshold voltage value is exceeded and is not selectively connected/disconnected by the control system/control device 240.

In one example, the tap changer module 300 can have a mechanical clamping device (not shown) which is so adapted that it exerts mechanical pressure at least on the crowbar and in so doing ensures proper operation. In one example, the tap changer(s) and the crowbar(s) of the on-load tap changer module 300 can be arranged within a single mechanical clamping device. In one example, a plurality of mechanical clamping devices can be used. Thus, each tap changer and/or each crowbar, for example, can be arranged within a respective mechanical clamping device.

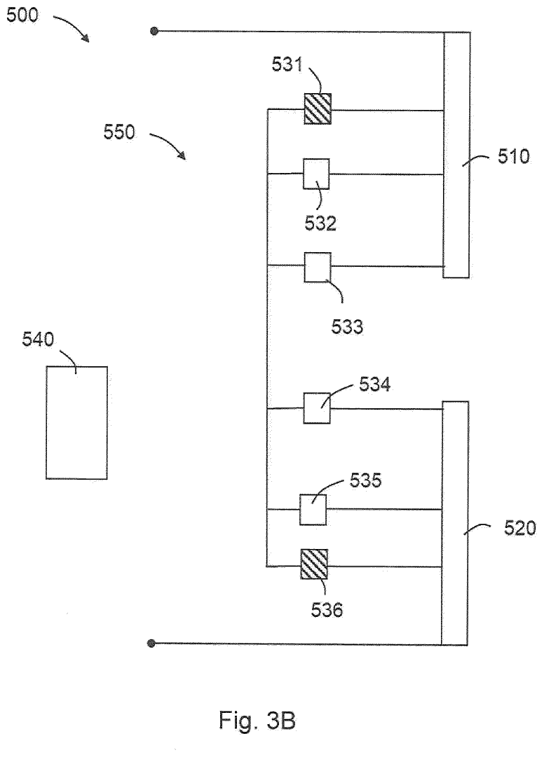

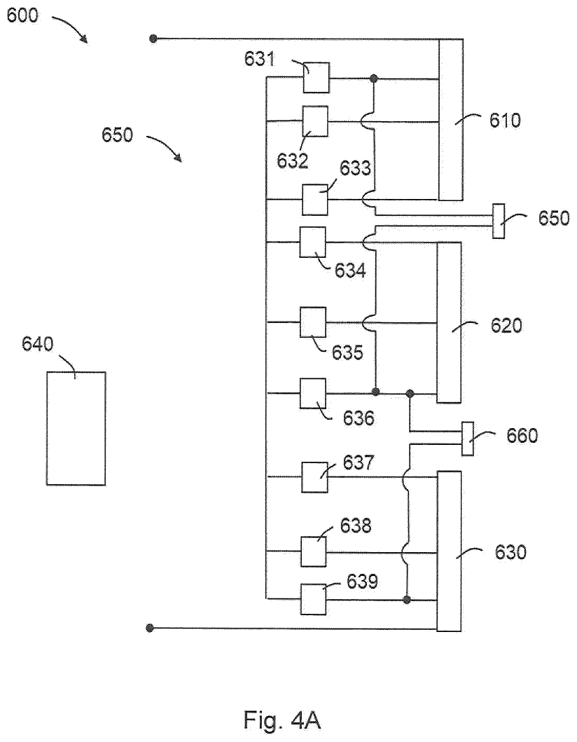

FIG. 3A shows an on-load tap changer module 400 according to a further example. The on-load tap changer module 400 can comprise two transformer windings 410, 420, a control system or control device 440, and a crowbar 450 according to one of the examples shown.

The on-load tap changer module 400 differs from the on-load tap changer module 200 of FIG. 2A in that it can have a plurality of tap changers. The on-load tap changer module 400 can have six changers 431, 432, 433, 434, 435, 436 according to each of the disclosed examples. By means of a plurality of tap changers, a more versatile on-load tap changer module can be provided, because more transformation ratios can be provided with the same number of transformer windings.

In the example of FIG. 3A, each end of the crowbar 450 can be connected to the changer pair that provides the current path having the lowest impedance, that is to say to the tap changer 431 and the tap changer 436. By bypassing the transformer tap windings by way of the current path having the lowest impedance, ramping up of the system can be made possible and, in addition, damage to the system in the case of an internal fault can be prevented. In one example, the crowbar 450 can be connected directly or indirectly at any desired point of the first and second transformer windings 410, 420.

The on-load tap changer module 400 can further have a mechanical clamping device (not shown). In one example, a single mechanical clamping device can comprise all the changers and crowbar(s) arranged therein. In some examples, a plurality of mechanical clamping devices can be used, for example each changer and each crowbar can be arranged within a respective mechanical clamping device.

FIG. 3B shows an on-load tap changer module 500 which can comprise two windings 540, 520, a control system/control device 540, and four tap changers 522-535 in accordance with one of the examples disclosed herein. The on-load tap changer module 500 differs from the on-load tap changer module of FIG. 3A in that the crowbar 550 is formed by two tap changers of the on-load tap changer module.

In the example shown, the changers 531 and 536 are designed for implementing the crowbar 550, because they define the current path having the lowest impedance. However, any other tap changers can be used for implementing the crowbar.

As in the examples of FIG. 1A and 2B, the changers that implement the crowbar can be similar to any of the examples disclosed herein, but which can be connected and disconnected when a predetermined threshold voltage value is exceeded and are not selectively connected and disconnected by the control system/control device 540.

FIG. 4A shows an on-load tap changer module 600 according to yet a further example. The on-load tap changer module 600 can comprise three transformer windings 610, 620, 630, a control system/control device 640, and a plurality of tap changers, for example nine tap changers 631-639 in accordance with one of the examples disclosed herein.

The on-load tap changer module can further have two crowbars 650, 660 in accordance with one of the examples disclosed herein. One end of each crowbar 650, 660 can be connected directly or indirectly to a point/terminal of a transformer winding 610, 620, 630 and the other end can be connected directly or indirectly to a point/terminal of a following transformer winding 610, 620, 630.

In FIG. 4A, a first crowbar 650 can be connected at one end to the first winding 610 and at the other end to the second winding 620. In addition, a second crowbar 660 can be connected at one end to the second winding 620 and at the other end to the third winding 630. In one example, the two crowbars can be so connected that they form the current path having the lowest impedance between two successive windings, that is to say between the first and the second winding and between the second and the third winding.

All the crowbars of the on-load tap changer module 600 can be so adapted that they are connected when the same threshold voltage value, for example approximately 7 kV, is exceeded, whereby a predefined current path via which the current can flow is determined.

The on-load tap changer module 600 can further have a mechanical clamping device (not shown). In one example, a single mechanical clamping device can comprise all the changers and crowbar(s) arranged therein. In some examples, a plurality of mechanical clamping devices can be used, for example each changer and each crowbar can be arranged within a respective mechanical clamping device.

FIG. 4B shows an on-load tap changer module 700 which is similar to the on-load tap changer module 600 of FIG. 4B. The on-load tap changer module 700 can comprise a control system/control device 740, a plurality of windings, for example three windings 710-730, and a plurality of tap changers, for example six tap changers 732-735, 737, 739 in accordance with one of the examples disclosed herein.

The on-load tap changer module 700 differs from that of FIG. 4A in that the crowbars 750, 760 can be formed by tap changers of the on-load tap changer module. In the example of FIG. 4B, the crowbar 750 can be formed by the tap changers 731 and 736, while the crowbar 760 can be formed by the tap changers 736 and 738. As in the example of FIG. 3B, the tap changers that implement a crowbar can be similar to those in any of the examples disclosed herein but so adapted that they are connected and disconnected when a predetermined threshold voltage value is exceeded and are not selectively connected and disconnected by the control system/control device 740.

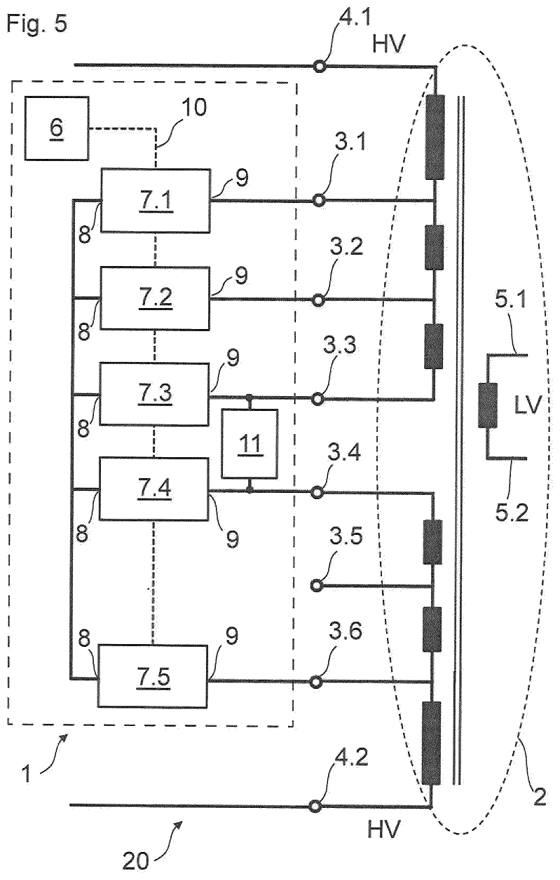

FIG. 5 shows a circuit diagram of an exemplary embodiment of an on-load tap changer module 1 for adjusting a transformation ratio of a power transformer 2 according to the invention. In the example shown, the power transformer 2 can be a multiphase low-, medium- or high-voltage transformer, wherein FIG. 5 shows only one phase thereof. The power transformer 2 can be designed, for example, for powers in a range of from approximately 1 MVA to approximately 100 MVA, without necessarily being limited thereto.

It is apparent from FIG. 5 that the transformer 2 can have different winding taps 3.1, 3.2, 3.3, 3.4, 3.5, which are also referred to herein as taps or step taps 3, of a transformer winding or tap winding (here on the high side). By way of the transformer terminals 4.1 and 4.2 on the high side, a high voltage can be supplied to the transformer 2 in the present example, for example in a range of from approximately 1 kV to approximately 50 kV or from approximately 1 kV to approximately 60 kV or even higher than 60 kV, without necessarily being limited to the above-mentioned voltage values. The power transformer 2 of the exemplary embodiment shown can accordingly be referred to as a high-voltage transformer. The transformer winding on the low side can have transformer terminals 5.1 and 5.2 on the low side, at which the transformed low voltage can be drawn from the transformer 2, for example alternating current voltages of less than 1000 V.

In the example shown in FIG. 5, the taps 3.1, 3.2 and 3.3 can be used to change the voltage in steps of predetermined percentages. The number and size of the adjustable steps can be defined beforehand according to the specific application.

It is further apparent from FIG. 5 that the exemplary on-load tap changer module 1 has an electronic control device 6 and in the present case a total of five tap changers 7, namely 7.1, 7.2, 7.3, 7.4, 7.5, which are controllable, that is to say substantially can be connected and disconnected, by means of the control device 6.

For example, the changers can be electronic changers, electromechanical changers or a combination thereof.

The control device 6 can have, for example, an electronic computing and memory unit (not explicitly shown), such as, for example, a microprocessor, microcontroller or the like, as well as volatile and/or non-volatile memory in the form of RAM, ROM, flash memory, etc.

The tap changers 7 each have a first electrical terminal 8 via which they can be connected together or interconnected, as is here apparent from FIG. 5. The tap changers 7 further each have a winding-side, second electrical terminal 9, via which they can each be connected or here have been connected to one of the taps 3 of the transformer winding, as is likewise apparent from FIG. 5.

The tap changers 7 can alternately be moved or switched between their respective two terminals 8 and 9 into the conducting and non-conducting state. The control device 6 is adapted to switch the tap changers 7 into their respective states by way of corresponding control signals 10 which are supplied to the tap changers 7, as is indicated in FIG. 5. The control signals 10 can be electrical or optical signals. In the present case, the control signals 10 are optical control signals, without necessarily being limited thereto.

By switching the tap changers 7 into their respective conducting or blocking states, the control device 6 can adjust the effective transformation ratio of the transformer 2, as has already been described hereinbefore.

It is further apparent from FIG. 5 that in the present case the second, winding-side terminals 9 of the two tap changers 7.3 and 7.4 can be electrically connected together directly or indirectly by way of a crowbar 11 for voltage limitation. Although in the present case the changers 7.3 and 7.4 are electrically connected by way of the crowbar, other changers can also be electrically connected by means of the crowbar 11 and/or further crowbars (not shown).

The crowbar 11 of the exemplary on-load tap changer module 1 shown can have two, or a pair of, toggle diode structures 12.1, 12.2 which are connected in anti-parallel and which in the present example are in the form of a thyristor with a break-over diode structure (BOD) and each have a predetermined breakdown voltage, the toggle diode structures 12 automatically being moved from their non-conducting, blocking basic state into a conducting state when the respective predetermined breakdown voltage is exceeded. Accordingly, in the example shown here, the winding-side terminals 9 of the two tap changers 7.3 and 7.4 and accordingly also the winding taps 3.3 and 3.4 of the transformer 2 can automatically be short circuited by way of the crowbar 11, depending on the voltage level and voltage polarity that is instantaneously present between the taps 3.3 and 3.4, when the corresponding breakdown voltage of the toggle diode structures 12.1 and 12.2 is exceeded. Accordingly, by purposively setting the breakdown voltages, which may substantially be the same or different, an overvoltage between the terminals 3.3 and 3.4 connected together by way of the crowbar 11 can reliably be avoided.

The electrical voltage in low-, medium- or high-voltage networks, for example in wind power, photovoltaic or railway power supply installations, can be unstable, in particular can fluctuate in a range of from −20% to +20% of the nominal voltage. A tapped transformer such as the transformer 2 shown in FIG. 5 can effectively respond to such voltage fluctuations.

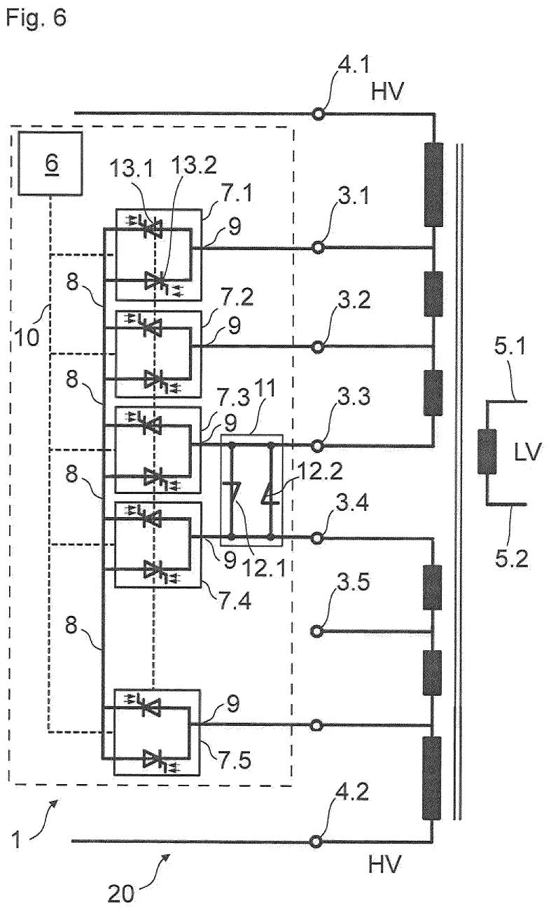

In order to be able to respond as quickly as possible to such voltage fluctuations, the tap changers 7 of the on-load tap changer module 1 can each have between their first and second terminals 8 and 9 two, or a pair of, power semiconductor switches 13.1 and 13.2 which are connected in anti-parallel and are controllable by the control device 6 and which can be in the form of thyristors, as can be seen in FIG. 6 in a more detailed view of the on-load tap changer module 1 of FIG. 5. For example, the power semiconductor switches 13.1 and 13.2 of the on-load tap changer module 1 can be in the form of light-triggered thyristors (LTT), without necessarily being limited thereto. The LTTs 13.1 and 13.2 can be controllable, that is to say in each case switchable between their conducting and non-conducting, blocking states (switchable on and off), by way of the optical control signal 10 outputted by the control device 6. In FIG. 6, the power semiconductor components 13.1 and 13.2 are identified by their own reference signs only for the tap changer 7.1. It will be appreciated, however, that the further tap changers 7.2, 7.3, 7.4 and 7.5 can each likewise have thyristors or LTTs 13.1 and 13.2 in the same way as the tap changer 7.1.

The control device 6 of the on-load tap changer module 1 shown in FIGS. 5 and 6 does not have to have a (separate, additional) auxiliary power source from which it is supplied for operation. Instead, the control device 6 can here be supplied solely from the installation voltage, that is to say from the electrical voltage HV or LV which is to be transformed by the power transformer 2 or which is supplied to or can be drawn from the power transformer.

Consequently, on start-up of the electrical installation or on restarting following a power failure, that is to say generally in the case of a cold start, where the voltage, for example low, medium or high voltage, to be transformed by the transformer is not yet present, the control device 6 of the on-load tap changer module 1 cannot be ready to switch the tap changer 7 properly. In other words, on start-up, an accidental switching state of the tap changers 7 in question which cannot yet be controlled by the control device 6, which is temporarily in a non-operational state, can be present. In the example shown in FIGS. 5 and 6, this can have the result that the voltage between the taps 3.3 and 3.4 increases to the value of the input voltage HV. In order reliably to prevent an unsafe operating state and possible damage to the tap changers 7, in particular when thyristors are used as the tap changers, the crowbar 11 can provide the desired overvoltage protection in that the breakdown voltage, for example of the toggle diode structures 12.1 and 12.2, is set at a value which is significantly below the input voltage HV, so that the toggle diode structures short circuit during such an overvoltage state.

Activation/powering on of the crowbar 11 in the case of a well-defined overvoltage allows the electrical installation to always run under safe operating conditions until the control device 6 is operational and is able to assume proper control of the tap changers 7 or thyristors 13. When all the winding taps 3 are properly controlled by the control device 6 by way of the tap changers 7, the voltage, for example between the taps 3.3 and 3.4, is again at a low voltage level below the predetermined breakdown voltages of the toggle diode structures 12.1 and 12.2, so that the crowbar 11 can become inactive and non-conducting and consequently cannot interfere with normal operation of the installation.

The on-load tap changer module 1 provides safe, controlled and robust start-up without external activation of or supply of power to the on-load tap changer module 1 or the control device 6. This can be particularly advantageous if, in the absence of installation power, an auxiliary voltage/auxiliary power supply is not available for the on-load tap changer module 1 or the control device 6.

In the event of a failure of the crowbar 11, the toggle diode structures (or other elements) of the crowbar are short circuited and nevertheless always maintain the system in a safe operating state.

The number and arrangement of the crowbar can be flexible and not necessarily limited to the example shown in FIGS. 5 and 6. Depending on the specific application, crowbar(s) can be provided which electrically connect, for example, the taps 3.3 and 3.4 or 3.1 and 3.5 or other combinations of taps 3 and reliably protect them from overvoltage. In principle, the crowbar 11 can be connected to all the taps 3.

Furthermore, in cases (not shown) in which the power transformer has a single tap winding, the on-load tap changer module can effectively be used with the effects and advantages described herein. In this case, in each case one tap changer of the on-load tap changer module can be connected, as shown in FIGS. 5 and 6, to one of two winding taps of the single tap winding of the transformer, wherein an additional third tap changer has been/is provided, which can then be permanently open during normal operation of the electrical installation and can be switched to the conducting state as required (e.g. when the control device is without power) in order to ensure safe operation of the installation within the meaning of the present invention.

It should further be pointed out that the configuration shown in FIGS. 5 and 6 can be used in an assembly 20 which can have the power transformer 2 having the various taps 3 of the transformer winding, and the on-load tap changer module 1 according to the invention for adjusting the transformation ratio of the power transformer 2, wherein the winding-side, second electrical terminals 9 of the tap changers 7 can each be electrically connected to one of the taps 3 of the transformer winding.

The adjustment of the transformation ratio of the power transformer 2 can, by way of example, be carried out by means of the on-load tap changer module 1 of FIG. 5 in that there are provided, for example, three tap changers 7 which are controllable by the control device 6 for adjusting the transformation ratio. The tap changers 7 can be electrically connected together in each case by way of their first electrical terminal 8, the winding-side, second electrical terminals 9 of the tap changers 7 can each be electrically connected to one of the taps 3 of the transformer winding. The winding-side, second terminals 9 of at least two of the tap changers 7 can be connected together by way of the crowbar 11 for voltage limitation. For example, the crowbar can to this end be provided with a pair of toggle diode structures 12.1 and 12.2 which are connected in anti-parallel and electrically connect together the winding-side terminals 9 of the at least two tap changers 7 and which each have predetermined breakdown voltages. The tap changers 7 can be adapted to selectively be switched by means of the control device 6.

For example, the control device 6 can be supplied solely from the electrical voltage HV, LV which is to be transformed by the power transformer 2 or is supplied to or can be drawn from the power transformer.

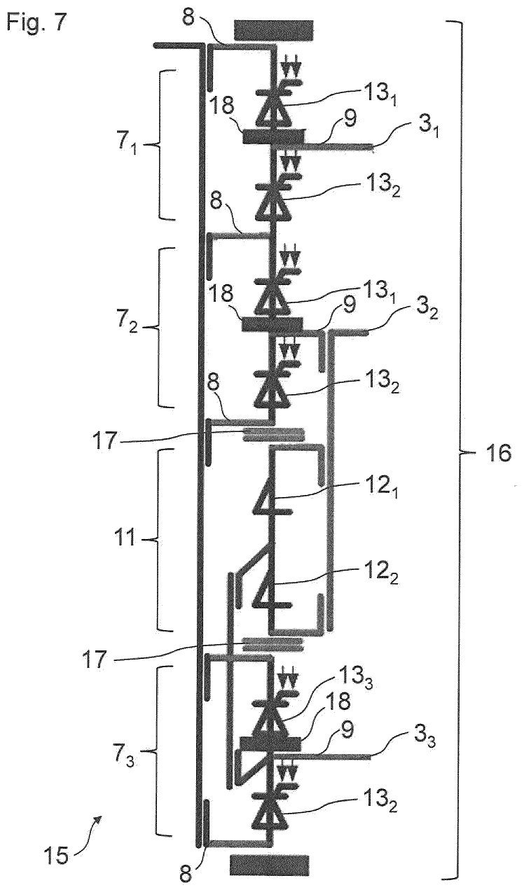

FIG. 7 shows a further exemplary embodiment of an on-load tap changer module 15 for adjusting a transformation ratio of a power transformer (not shown) according to the invention. The on-load tap changer module 15 of FIG. 7 can correspond substantially to the on-load tap changer module 1 of FIG. 5.

Unlike the on-load tap changer module 1, however, the on-load tap changer module 15 has three electronic tap changers 7.1, 7.2 and 7.3. Each of these tap changers 7 can have between its first and second terminals 8, 9 two power semiconductor switches 13.1, 13.2 which are connected in anti-parallel and are selectively controllable by a control device and which can be in the form of, for example, thyristors, in particular light-triggered thyristors. The control device of the on-load tap changer module 15 for adjusting the transformation ratio of the transformer by selectively switching the tap changers 7 is not shown in FIG. 7. The interconnection of the tap changers 7.1, 7.2 and 7.3 in the case of the on-load tap changer module 15 with one another and with the taps 3.1, 3.2 and 3.3 can correspond to the interconnection as in the case of the on-load tap changer module 1 of FIG. 5.

Furthermore, in the case of the on-load tap changer module 15, the crowbar 11 can be connected between the taps 3.2 and 3.3 and can again have the two toggle diode structures 12.1 and 12.2 which are connected in anti-parallel and each have their predetermined breakdown voltages. In the case of the on-load tap changer module 15, the toggle diode structures 12.1 and 12.2 can each be in the form of separate thyristors having a break-over diode structure (BOD) as overvoltage protection, which can likewise be light-triggered thyristors (LTT), without necessarily being limited thereto. The light triggering of the LTTs forming the toggle diode structures 12.1 and 12.2 does not have to be required for the invention and can therefore remain unused in the case of the on-load tap changer module 15. The thyristors can be triggered, that is to say switched into their conducting state, solely by way of the BOD structures 12.1 and 12.2 in the presence of an overvoltage above the predetermined breakdown voltage in question.

In addition to the BOD structure, which can provide overvoltage protection in dependence on a predetermined voltage level, the thyristors forming the toggle diode structures 12.1 and 12.2 of the crowbar 11 can also have so-called du/dt protection, which is able to trigger or connect through the crowbar thyristors in dependence on a predetermined gradient of a voltage change. In this manner, the thyristor can switch to conducting even before the breakdown voltage is exceeded at the toggle diode structures 12.1 and 12.2, so that the on-load tap changer module is able to react quickly to highly transient voltage events.

As is apparent from FIG. 7, the thyristors 13.1 and 13.2 forming the power semiconductor switches and the thyristors forming the toggle diode structures 12.1 and 12.2 can be arranged so that they are together mechanically stacked, or stacked one above the other, in a thyristor stack 16 and can be press-contacted (press pack). The thyristors forming the crowbar 11 can in each case be electrically insulated with respect to the geometrically adjacent tap changers 7.2 and 7.3 by means of insulators 17 which are inserted into the stack. In addition, in the thyristor stack 16, the two thyristors of a tap changer 7.1, 7.2, 7.3 that form the power semiconductor switches can be cooled by means of an inserted common cooling box 18.

The configuration both of the power semiconductor switches of the tap changers 7.1, 7.2, 7.3 and of the toggle diode structures 12.1, 12.2 of the crowbar 11 as thyristors which, without necessarily being limited thereto, can be configured identically in respect of their geometric and/or technical properties offers the particular advantage that a conventional thyristor stack can be replaced by the on-load tap changer module 15 according to the invention without a great outlay even in existing energy installations.

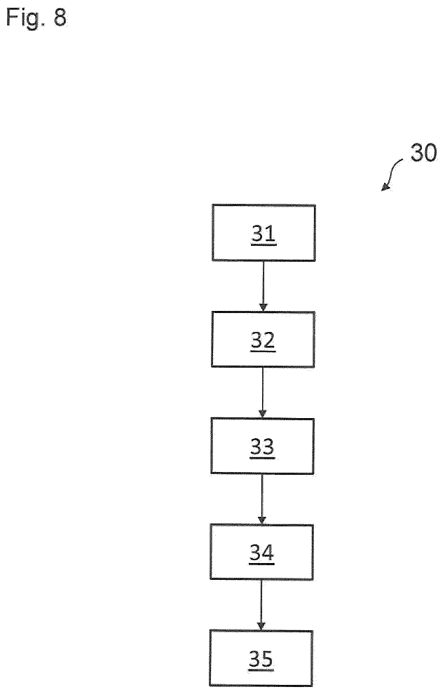

FIG. 8 shows a flow diagram of an exemplary embodiment of a method 30 for operating an on-load tap changer module according to the invention. The on-load tap changer module can be, for example, one of the on-load tap changer modules shown in FIGS. 1 to 7, without necessarily being limited thereto.

In a first step 31 of the method 30 shown in FIG. 8, a control device, for example, without necessarily being limited thereto, the control device 6 of FIG. 5, is provided.

In a further step 32, there is provided a power transformer, for example the power transformer 2 of FIG. 5, having at least one transformer winding which has and provides at least one tap, for example, without necessarily being limited thereto, at least one of the taps 3 of the power transformer 2 in FIG. 5.

In yet a further step 33 of the method 30, there is provided at least one tap changer which can selectively be connected and disconnected by means of the control device in order to adjust a transformation ratio of the power transformer, for example, without necessarily being limited thereto, at least one of the tap changers 7 of FIG. 5.

Furthermore, in a step 34 of the exemplary method 30, at least one crowbar for voltage limitation, for example, without necessarily being limited thereto, the crowbar 11 of FIG. 5, is provided.

In step 35, a predetermined current path is provided by means of the at least one crowbar when a predetermined threshold voltage value is exceeded, in order to determine a predetermined transformation ratio of the power transformer. In other words, the predetermined current path is provided and accordingly determined by activation (i.e. short circuiting) of the crowbar as a result of the threshold value being exceeded.

Although the present invention has been described in detail with reference to the preferred embodiments, it will be appreciated that the present invention is not limited by the examples disclosed herein, and that numerous additional modifications and variations thereof could be made by a person skilled in the art without deviating from the scope of the invention.

The on-load tap changer module described herein, the assembly comprising a power transformer and an on-load tap changer module, and the method for operating an on-load tap changer module are not limited to the embodiments shown herein but also include further embodiments which result from technically expedient further combinations of the features that are described herein of each subject matter and which have the same effect. In particular, the features and feature combinations mentioned hereinbefore in the general description and in the description of the figures and/or shown solely in the figures can be used not only in the combinations explicitly indicated herein but also in different combinations or in isolation, without departing from the scope of the present invention.

In a particularly preferred embodiment, the on-load tap changer module, in particular the power electronic on-load tap changer module, according to the invention is used for adjusting a transformation ratio of a power transformer, for example a high-voltage transformer, in wind power installations, wherein the use is not necessarily limited to wind power installations but can likewise include, for example, photovoltaic installations, railway power networks and other electrical energy networks, in particular medium- and high-voltage networks.

### LIST OF REFERENCE SIGNS

1 on-load tap changer module
2 power transformer
3 winding tap, tap
4 transformer terminal on the high side
5 transformer terminal on the low side
6 control device
7 tap changer
8 first terminal
9 second, winding-side terminal
10 control signal
11 crowbar
12 toggle diode structure
13 power semiconductor switch, thyristor
15 power electronic on-load tap changer module
16 thyristor stack
17 insulator
18 cooling box
20 assembly
30 method for operating an on-load tap changer module
BOD break-over diode structure
HV high voltage
IGBT insulated gate bipolar transistor
IGCT integrated gate-commuted thyristor
LV low voltage

1-20. (canceled)

21. An on-load tap changer module for adjusting a transformation ratio of a power transformer that has at least one transformer winding providing at least one tap, the on-load tap changer module comprising:
a control device;
at least one tap changer configured to be selectively connected and disconnected by the control device to adjust a transformation ratio of the power transformer; and
at least one crowbar for voltage limitation and which is configured, when a predetermined threshold voltage value is exceeded, to provide a predetermined current path for determining a predetermined transformation ratio of the power transformer.

22. The on-load tap changer module of claim 21, wherein the on-load tap changer module has at least two tap changers.

23. The on-load tap changer module of claim 21, wherein the on-load tap changer module has at least three tap changers which are each connected together by way of a first electrical terminal and are each configured to be connected by way of a winding-side, second electrical terminal to one of a plurality of taps of the transformer winding, and wherein the winding-side, second terminals of at least two of the tap changers are electrically connected together by way of the crowbar for voltage limitation.

24. The on-load tap changer module of claim 21, wherein the crowbar has at least one toggle diode structure having a predetermined breakdown voltage.

25. The on-load tap changer module of claim 21, wherein the crowbar has a pair of toggle diode structures which are connected in anti-parallel and which each have a predetermined breakdown voltage.

26. The on-load tap changer module of claim 21, wherein the at least one tap changer has a pair of thyristors connected in anti-parallel.

27. The on-load tap changer module of claim 26, wherein the thyristors are light-triggered thyristors.

28. The on-load tap changer module of claim 21, wherein the crowbar has at least one thyristor.

29. The on-load tap changer module of claim 28, wherein the thyristor has a break-over diode structure forming a toggle diode structure.

30. The on-load tap changer module of claim 28, wherein the crowbar has a further switch and an impedance.

31. The on-load tap changer module of claim 21, wherein the crowbar has at least one insulated gate bipolar transistor (IGBT) or integrated gate-commuted thyristor (IGCT).

32. The on-load tap changer module of claim 21, further comprising:
a mechanical clamping device configured to exert mechanical pressure on the crowbar.

33. The on-load tap changer module of claim 21, wherein the crowbar has at least one of the tap changers.

34. The on-load tap changer module of claim 21, wherein the on-load tap changer module has a plurality of crowbars.

35. The on-load tap changer module of claim 34, wherein the number of crowbars is dependent on the number of transformer windings and is proportional to a number of transformer phases.

36. A wind power installation comprising the on-load tap changer module of claim 21.

37. An assembly, comprising:
a power transformer having at least one transformer winding providing at least one tap; and
an on-load tap changer module comprising:
a control device;
at least one tap changer configured to be selectively connected and disconnected by the control device to adjust a transformation ratio of the power transformer; and
at least one crowbar for voltage limitation and which is configured, when a predetermined threshold voltage value is exceeded, to provide a predetermined current path for determining a predetermined transformation ratio of the power transformer.

38. The assembly of claim 37, wherein the on-load tap changer module has at least two transformer windings.

39. A method for operating an on-load tap changer module, the method comprising:
providing a control device;
providing a power transformer having at least one transformer winding providing at least one tap;
providing at least one tap changer configured to be selectively connected and disconnected by the control device to adjust a transformation ratio of the power transformer;
providing at least one crowbar for voltage limitation; and
providing a predetermined current path by the at least one crowbar when a predetermined threshold voltage value is exceeded, to determine a predetermined transformation ratio of the power transformer.

40. The method of claim 39, wherein at least two tap changers and/or at least two transformer windings are provided.
